(19) United States
(12) Patent Application Publication
(10) Pub. No.: US 2012/0124388 A1
(43) Pub. Date: May 17, 2012

(54) Electronic-device theft-deterring systems

(75) Inventors: Weng Wah CHNG, The Equation (SG); Yang Kwang HAN, The Equation (SG)

(73) Assignee: DiSa DigitalSafety Pte Ltd, The Equation (SG)

(21) Appl. No.: 12/945,883

(22) Filed: Nov. 14, 2010

(51) Int. Cl. G06F 21/00

(52) U.S. Cl. 713/189; 726/35

(57) ABSTRACT

A method and apparatus to deter theft of electronic-devices is disclosed. Electronic-devices have locked and unlocked states that permit deny and permit use of the electronic-device. Electronic-devices are shipped from manufacturers, thorough suppliers, to retailers in the locked state. Unlocking functions are transmitted through computer networks to the retail locations and held in volatile storage. The unlocking of the electronic-device occurs subsequent to purchase. Other methods and apparatus are disclosed related to multiple distribution methods of unlocking schemes, re-locking and return validation and data structures.

### CROSS REFERENCE TO RELATED APPLICATIONS

Not applicable.

### BRIEF DESCRIPTION OF THE DRAWINGS

FIG. 1 shows a distribution architecture diagram illustrating entities distributing locked electronic-devices and transmitting the corresponding unlocking codes and keys through physical and computer-network channels of trade.

FIG. 2 shows a diagram illustrating the types of electronic-devices that may be locked and unlocked.

FIG. 3 shows a use case diagram illustrating how the manufacturers, suppliers, retailers and purchasers interact with the system.

FIG. 4 shows a start chart diagram illustrating the locked and unlocked states of the electronic-device.

FIG. 5A shows a data structure diagram illustrating the portions of the data that may be useful in generating the unlocking and re-locking keys.

FIG. 5B shows a data structure diagram illustrating the portions of the data that may be useful in verifying returns and re-locking devices.

FIGS. 6 to 8 show a series of sequence diagrams illustrating simultaneous distribution methods for device identifiers and pass-codes.

FIG. 6 further shows a sequence diagram illustrating a dissemination method for device identifiers and pass-codes where the identifiers and pass-codes originate from outside the manufacturer.

FIG. 7A further shows a sequence diagram illustrating another dissemination method where the device identifiers originate remotely from the manufacturer and the pass-codes are encrypted into a barcode which may be decrypted with a key held outside the manufacturer.

FIG. 7B further shows a sequence diagram illustrating another dissemination method, similar to FIG. 7A, where the timing of the upload of the manufacturing facts occurs around the time of sale.

FIG. 8 further shows a sequence diagram illustrating another dissemination method where the identifiers, keys and/or pass-codes originate from the manufacturer and held outside the manufacturer.

FIG. 9 shows a sequence diagram illustrating a method of verifying a return using sales info captured during the unlocking sequence.

FIG. 10 shows a state chart diagram illustrating the states for a remote server for holding unlocking pass-codes, encryption keys, and other sensitive data within the retailer's physical location.

### DETAILED DESCRIPTION

The present Electronic-Device Theft-Deterring Systems will now be discussed in detail with regard to the attached drawing figures, which were briefly described above. In the following description, numerous specific details are set forth illustrating the Applicant's best mode for practicing the Electronic-Device Theft-Deterring Systems and enabling one of ordinary skill in the art to make and use the Electronic-Device Theft-Deterring Systems. It will be obvious, however, to one skilled in the art that the present Electronic-Device Theft-Deterring Systems may be practiced without many of these specific details. In other instances, well-known manufacturing methods, software engineering considerations, electrical engineering considerations, encryption engineering considerations, and other details have not been described in particular detail in order to avoid unnecessarily obscuring this disclosure.

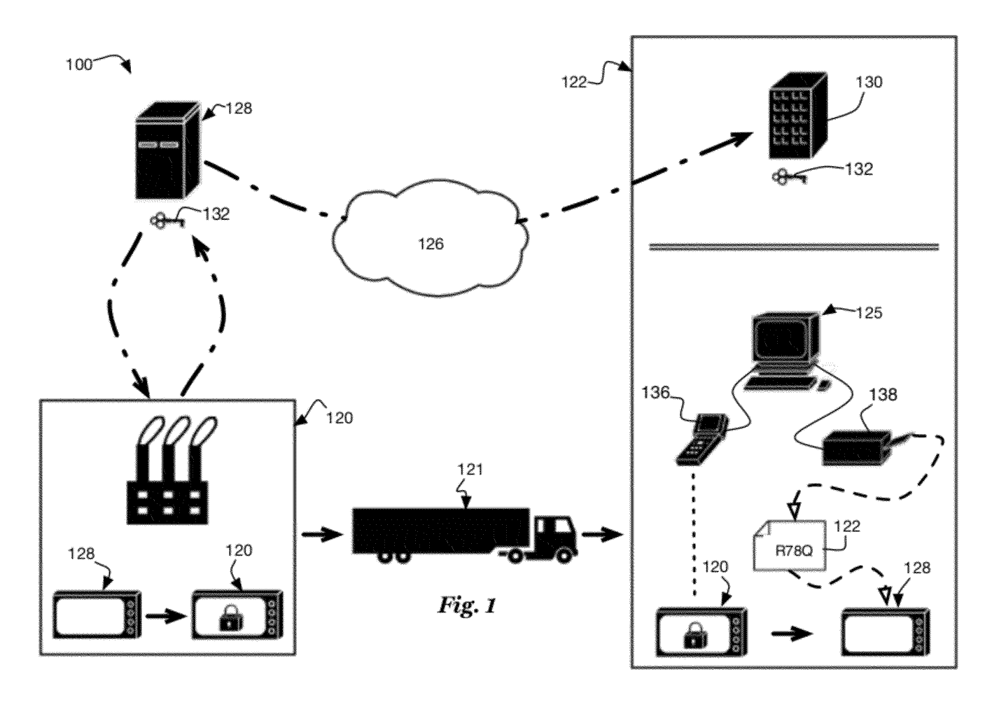

FIG. 1 shows a distribution architecture diagram illustrating entities distributing locked electronic-devices and transmitting the corresponding unlocking codes and keys through physical and computer-network channels of trade. System 100 shows manufacturers 110, suppliers 111, and retailers 112 participating in a system that allow the distribution of electronic-devices 118 while deterring theft of electronic-devices 118. System 100 allows manufacturers 110 and suppliers 111 to distribute locked electronic-devices 120.

Locked electronic-devices 120 have software programs, firmware, or other programming that prevents use of the features until after the device is unlocked, as shown. From the time of manufacture, through the distribution channel, and even while the electronic-device 118 is displayed by retailer 112, electronic-device 118 remains locked, as shown. At or after the time of purchase, an unlocking code 122 may be entered into the locked electronic-device 120, which unlocks and allows access to electronic-device 118, as shown. Since the locked electronic-device 120 cannot be used, theft of the locked electronic-device 120 may be ineffective, that is, since the electronic-device is inoperative there is no benefit to possessing the locked electronic-device 120, and thereby, there is no motive to steal the locked electronic-device 120.

To deliver unlocking code 122 to a purchaser at the point-of-sale 125 of the retailer 112, a remote server 128 and computer network 126 may be used. The computer network 126 and remote servers 128 may be independent of suppliers 111, as shown. The computer network 126 and remote servers 128 may be independent of manufacturers 110, as shown. The computer network 126 and remote servers 128 may be independent of retailers 112, as shown. The encryption keys 132 may be delivered through remote servers 128 to unlocking-code servers 140 that are locally available to retailers 112, as shown.

Such a system may deter theft by a variety of thieves. For example, it may work to discourage shoplifters because the packaging of the electronic-device may be marked to educate the shoplifter that the electronic-device requires unlocking after purchase. For example, it may work discourage employee theft and inventory shrink because employees will be aware of the post purchase requirement to unlock electronic-devices. For example, it may work to discourage organized crime because the amount of time to defeat the lock may be too long and organized crime typically desires to quickly fence the stolen goods.

Such a system may be low cost and may be developed with economic considerations. After installation of the system at a retailers point-of-sale 125, there is no ongoing labor cost to the retailer to maintain the theft deterring benefit. Supplier 111 benefits without any action by supplier 111. Manufacturer 110 does not need to compromise product design or final product usage, including battery life of mobile devices. For example, in some embodiments, the locking and unlocking functions may remove themselves from the electronic-device after purchase and the appropriate unlocking code 122 has been entered.

Additionally, there may be other economic considerations. For example, if the risk of theft is reduced, shipping costs may be reduced. For example, if the risk of theft is reduced, insurance costs may be reduced for the manufacturer 110, supplier 111, and retailer 112. If shoplifting theft is deterred, electronic-devices 118 may be displayed more prominently and sold more readily. Deterring of shoplifting theft may reduce inventory shrink by 35%. For example, if in-store theft is reduced, electronic-devices 118 may not need other types of physical security, for example locked merchandise displays, locked cages, merchandising monitoring programs, supply chain security measures, back-room security measures, plastic wraps, wireless inventory sensors, or other types of physical security. This may result in the saving on in-store fixtures. Elimination of employee theft may reduce inventory shrink by 45%. In other embodiments, by deterring fraud related to return of electronic-devices, inventory shrink maybe reduce another 10%. Finally, the system may displace other security measures thereby eliminating the cost of the other security measures.

Elimination of physical security measures may allow new opportunity for merchandising and thereby increase sales of electronic-devices.

To bring electronic-device 118 to market, the process begins with manufacturer 110, as shown. Manufacturer 110 builds electronic-device 118. Manufacturer 110 communicates with remote servers 128 to ensure that the necessary information to create an unlocking code 122 is available, as shown. In one embodiment, the unlocking information may include a device identifier to identify electronic-device 118, an encryption key 132, unknown encryption algorithm, and the password generation scheme. In other embodiments other parameters may be used to generate an unlocking code 122. Manufacturer 110 may print a barcode that contains a device identifier that corresponds to the unlocking code. For example, the barcode may be printed as a two-dimensional barcode with encryption.

Remote servers 128 transmit encryption keys 132 securely to retailers 112, as shown. Remote servers 128 may also make other information necessary to generate an unlocking code available to retailers 112. Remote servers 128 may communicate over a globally available network, such as computer network 128, communicate by private computer networks, as shown. In some embodiments, a portion of the unlocking scheme may be encrypted, attached to the electronic-device, for example, a two-dimensional barcode may contain an unlocking code that is encrypted but unreadable until decrypted. In other embodiments, the unlocking code may be generated using the device identifier, manufacturing facts or other data, for example, according to a password generation algorithm.

Unlocking-code servers 130 may contain encryption keys 132 and other information necessary to unlock electronic-devices 118. In some embodiments, unlocking-code servers 130 may only hold encryption keys 132 and other information in volatile storage, such as, random access memory of the computer. Volatile storage does not hold its contents through a disruption to the power supply. By holding any information needed to help unlock electronic-devices 118, theft of the unlocking-code server code servers 130 may be deterred. As such, theft of the unlocking-code servers 130 may not be effective because any theft will require disconnection of the unlocking-code server 130 from the power supply. Additionally, unlocking-code server 130 may be physically secured from the retail operations, including the retail point-of-sale 125, including the checkout locations, as shown.

When unlocking-code server 130 starts up and attempts to access remote servers 128, remote servers 128 may require authentication of unlocking-code server 130. Authentication may be automated, systematic or may require human intervention. When setting up a virtual private network with the unlocking-code server 130, unlocking-code server 130 may only hold the information required to set up and maintain the virtual private network on its volatile storage. This ensures that if power is disrupted to unlocking-code server 130, unlocking-code server will not be able to reconnect to remote servers 128 without re-authentication.

Unlocking-code server 130 may be responsive to messages from remote servers 128. Specifically, remote servers 128 may send messages to unlocking-code server 130 which require unlocking-code server 132 to delete all information related to determining unlocking codes 122 or connecting to remote servers 128. Remote servers 128 may also send messages to unlocking-code servers 130 which require him locking code server to self-destruct, for example, by deleting their operating systems. Finally, unlocking-code server 130 may respond to requests from remote servers 128 to ensure that unlocking-code server 130 is continuously available, its network connection is not disrupted, and it has not been compromised. In such an embodiment, unlocking-code server 130 may be required to have continuous power supply and continuous network operation.

At point-of-sale 125, when the consumer is ready to purchase an electronic-device 122, point-of-sale 125 reads the encrypted barcode on locked electronic-device 120 using barcode scanner 136, as shown. Barcode scanner 136 may be a two-dimensional barcode scanner reader capable of reading encrypted barcodes. Point-of-sale 125 transmits the information from the barcode to the local unlocking-code server 130, as shown. unlocking-code server 130 uses encryption key 132 to determine unlocking code 122, as shown. Some embodiments, unlocking-code server 130 may use a password generation algorithm to generate unlocking code 122. In some other embodiments, the barcode may not be encrypted.

Unlocking code 122 is transmitted back to point-of-sale 125 and printed on printer 138, as shown. Depending on the embodiment, unlocking code 122 may be automatically entered into locked electronic-device 120, printed on the receipt, and/or displayed on a screen at the point-of-sale 125. In any event, locked electronic-device 120 receives the locking code 122 and becomes an unlocked electronic-device 118 which is ready and available for use by the purchaser.

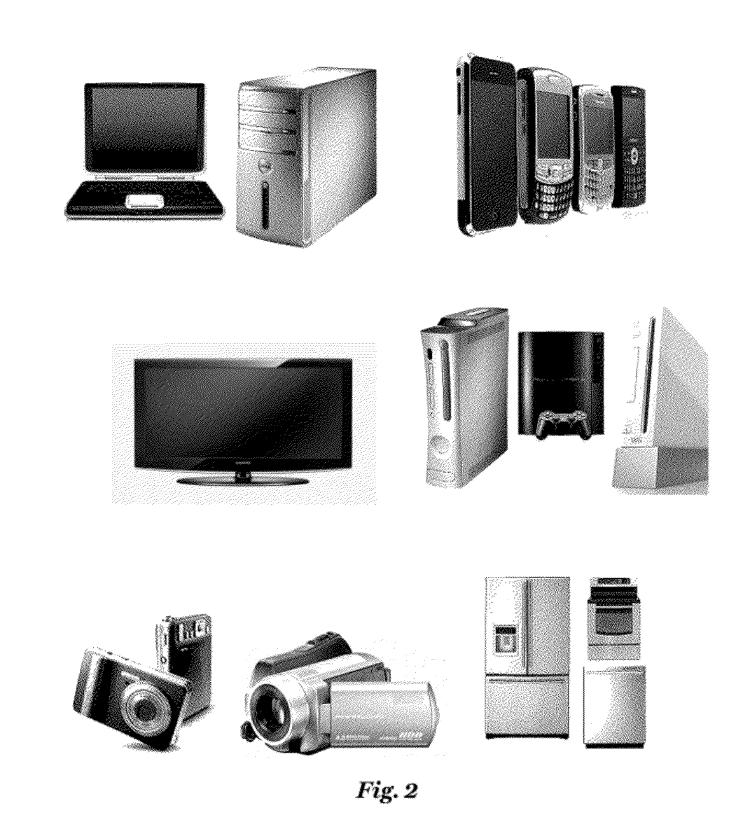

FIG. 2 shows a diagram illustrating the types of electronic-devices 118 that may be locked and unlocked. Electronic-devices 118 may include computers, for example, laptops, desktops, servers, networking equipment, and other computer devices. Electronic-devices 118 may include mobile or cellular phones, for example, smart phones, portable data assistants (PDA), global positioning systems (GPS) and other handheld mobile computing devices. Electronic-devices 118 may include household electronics, for example, television sets, radios, stereo equipment, and other devices capable of receiving input from consumers. Electronic-devices 118 may include gaming consoles, for example, gaming consoles that connect to television sets, handheld gaming consoles, etc. Electronic-devices 118 may include digital cameras, camcorders, etc. Electronic-devices 118 may include other household appliances, for example, refrigerators, stoves, microwave ovens, washers and dryers, and dishwashers.

Electronic-Devices 118 may include any mobile or electronic-device that contains a computer processor or programmable firmware that allows for a locked state and an unlocked state and transition between them using an unlocking code. The electronic-device may have a locked state, unlocked state, locking function and unlocking function. The locked state prevents use of the electronic-device. The unlocked state allows use of the electronic-device. The unlocking function transitions the electronic-device from the locked state to the unlocked state. The locking function returns the device to a locked state from an unlocked state. Electronic-device 118 may include any electronic-device that derive substantial benefit from software program, operating system, or other feature that responds to a computationally locked or unlocked state.

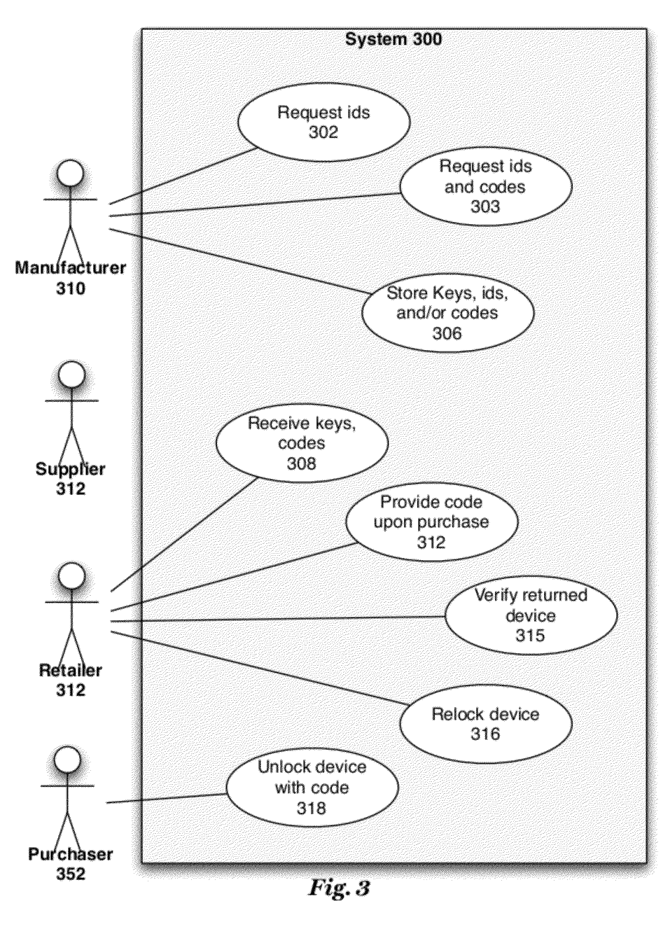

FIG. 3 shows a use-case diagram illustrating how the manufacturers 310, suppliers 311, retailers 312 and purchasers interact with system 300.

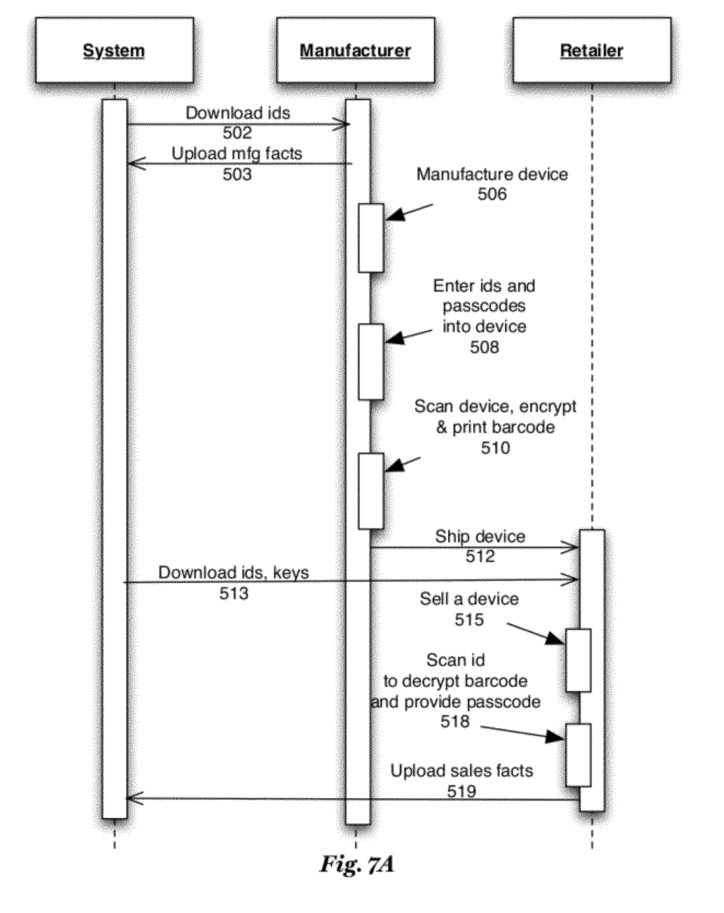

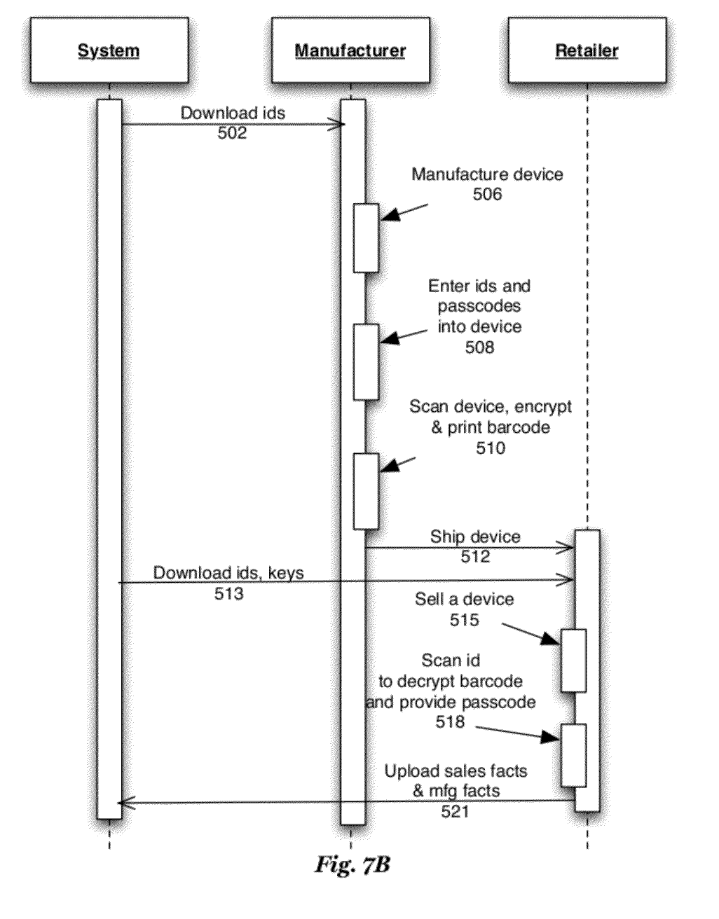

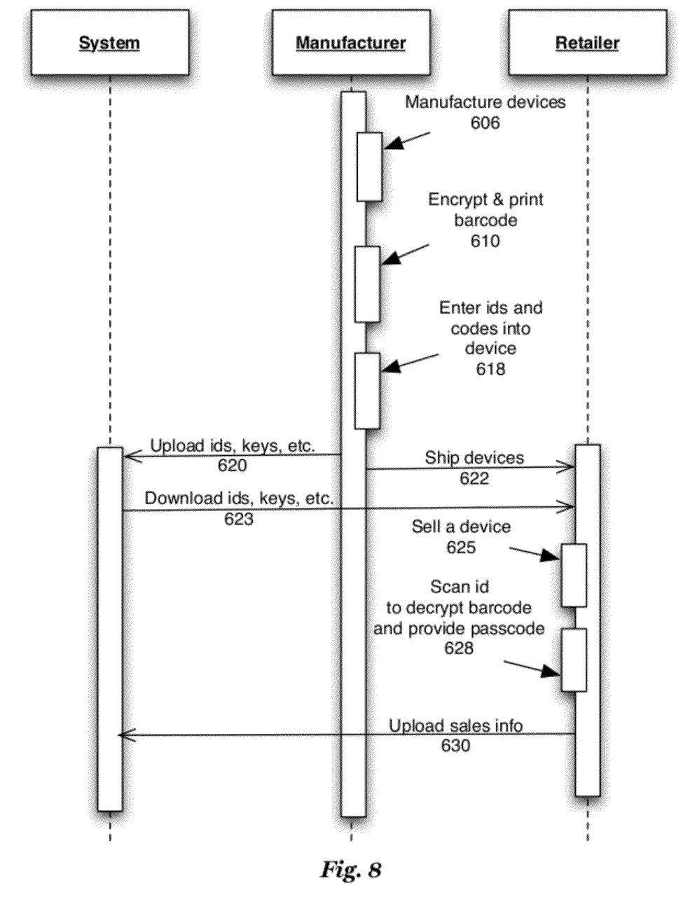

Manufacturer 310 may interface with system 300 in at least three ways. In use-case 302, manufacturer 310 may request device identifier from system 300, as shown. When manufacturer 310 requests device identifiers without unlocking codes, manufacturer 310 may generate its own unlocking scheme, for example, see FIGS. 7 and 8 along with the accompanying text.

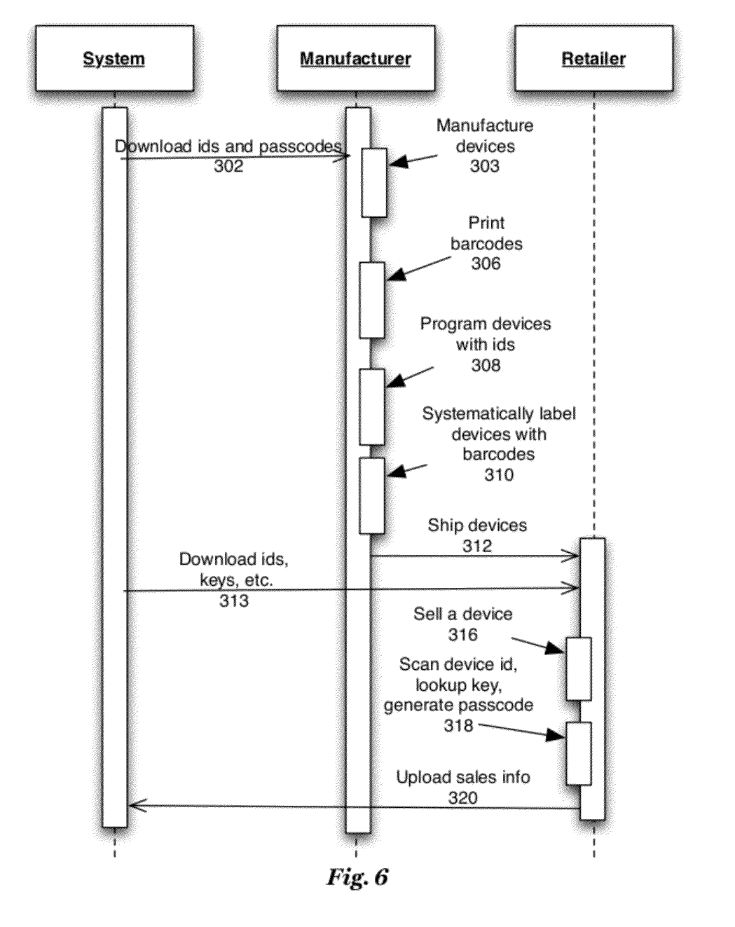

In use-case 303, manufacturer 310 may request device identifiers and unlocking codes, as shown. When manufacturer 310 requests both device identifiers and unlocking codes, manufacturer may be using a prearranged unlocking scheme, for example, see FIG. 6 and accompanying text.

In use-case 306, manufacturer 310 may store encryption keys and device identifiers that are for use with system 300, as shown. In some embodiments, system 300 may store unlocking codes from the manufacturer, as shown. In other embodiments, system 300 may store encryption keys used by manufacturer 310. In some embodiments, multiple methods may be used simultaneously by different manufacturers. In other words, combinations of encryption keys, unlocking codes, encryption algorithms, and other information capable of generating unlocking codes may be stored on system 300.

Supplier 311, while benefiting from system 300, may not be required to interact with system 300 directly. However, in some embodiments, supplier 311 may transmit or receive information from system 300 to report exceptional circumstances, for example, loss of the shipment, theft of the shipment, etc.

Retailer 312 may interface with system 300 in at least four ways, as shown. In use-case 308, retailer 312 may receive encryption keys, unlocking codes, encryption algorithms, other information capable of generating unlocking codes, or combinations thereof onto a locally available, unlocking-code server. In use-case 312, retailer 312 may provide an unlocking code to a purchaser or injure an unlocking code into a lock electronic-device after purchase, as shown. For further information about unlocking electronic-devices see the bottom portions of FIGS. 6, 7A, 7B, and 8, along with the accompanying text.

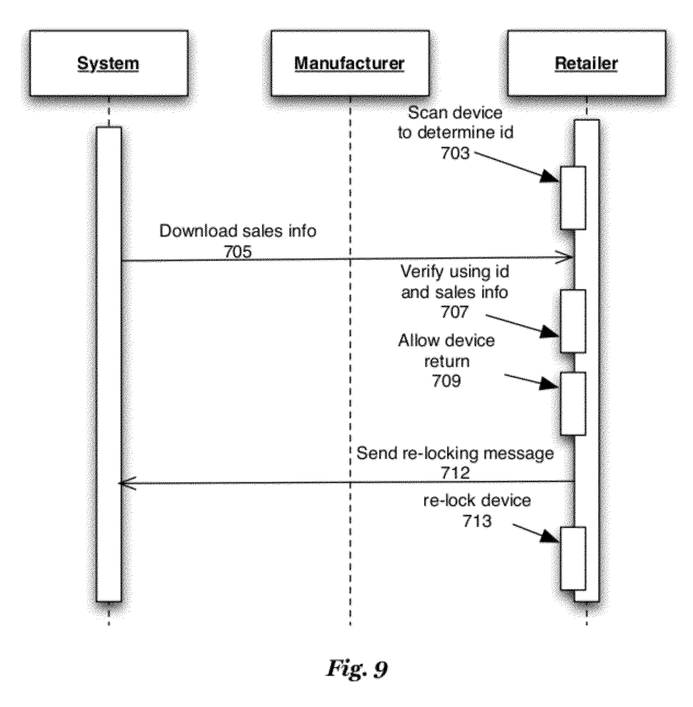

In use-case 315, retailer 312 may be accepting for return an electronic-device from a prior purchaser. Since the electronic-device is unlocked, retailer may request that the system validate that the electronic-device being returned is actually previously purchased from the retailer 312. After validation, retailer 312 may re-lock the device pursuant to use-case 316, as shown. For further information about validation of returns and reluctant devices see FIG. 9 and accompanying text.

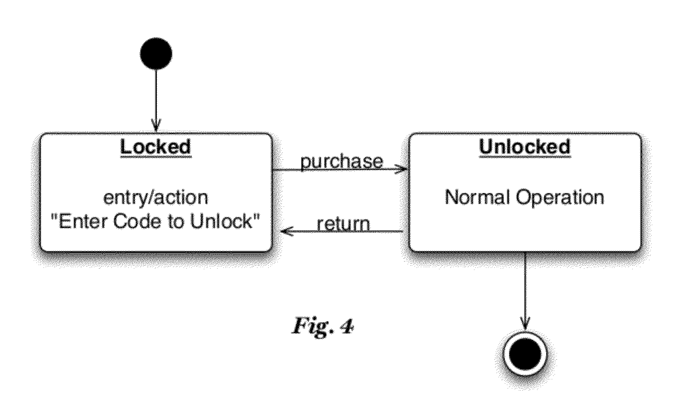

Purchaser 352 may interact with system 300 through use-case 318, as shown. Use-case 318 provides for the electronic-device purchased by the purchaser 352 to transition from a locked state to an unlocked state. For example, the purchaser may directly enter the unlocking code onto a cellular phone, computer, or other device capable of input. With other types of electronic-devices the locking code may be entered directly by the retailers point-of-sale system. For further information about locking and unlocking of electronic-devices see FIG. 4 and accompanying text.

FIG. 4 shows a start chart diagram illustrating the locked and unlocked states of the electronic-device.

For an electronic-device to be locked and unlocked, electronic-device may deliver features and functions through the operation of software, rather than the operation of purely mechanical equipment. Mechanical equipment controlled by software may also benefit from having a locked and unlocked states.

One way to create locked and unlock states would be to create a locking program that will accept a variable alphanumeric pass-code, such as, unlocking code. Unlocking code may vary in length for example from between 4 to 32 characters long. The individual unlocking code 122 may be written to each device, or alternately, the locking program may be able to determine the unlocking code using parameters, such as, the product serial number, or a other information available to the program.

In some embodiments, the locking program may allow the purchaser to lock and unlock the electronic-device. For example, it allows the user to enable or disable as well as to change the pass-code. After the initial unlock, the purchaser can re-lock and disable the device. This may allow the purchaser to deny use of the electronic-device to pickpockets (for example).

The ability to re-lock the device may also aid retailers. The product can be re-scanned for the original pass-code and manually change to that password for protection. This allows the device to be re-locked before further sale to another customer or return to the manufacturer.

There may be other ways to enable locked and unlocked states on electronic-devices. So long as the locking and unlocking can be accomplished through the transmission of at least a portion of the unlocking scheme through computer network, the system can be effective. For example, some portions of unlocking schemes include unlocking codes, encryption keys, encryption algorithm, and password generator programs.

In some embodiments, the retailer may re-lock by a sequence of codes that will transition the device from an unlocked state to a locked state. This would not require the retailer to change the pass-code. For example, the electronic-device may be locked with the original pass-code.

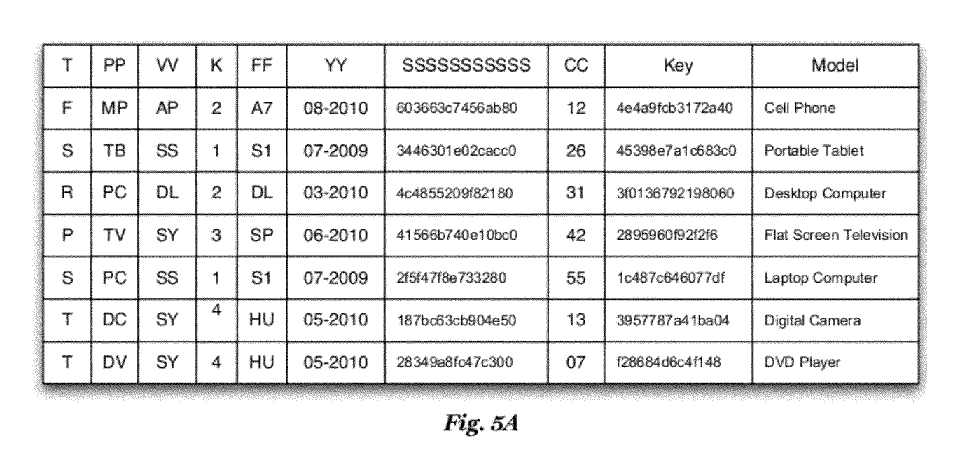

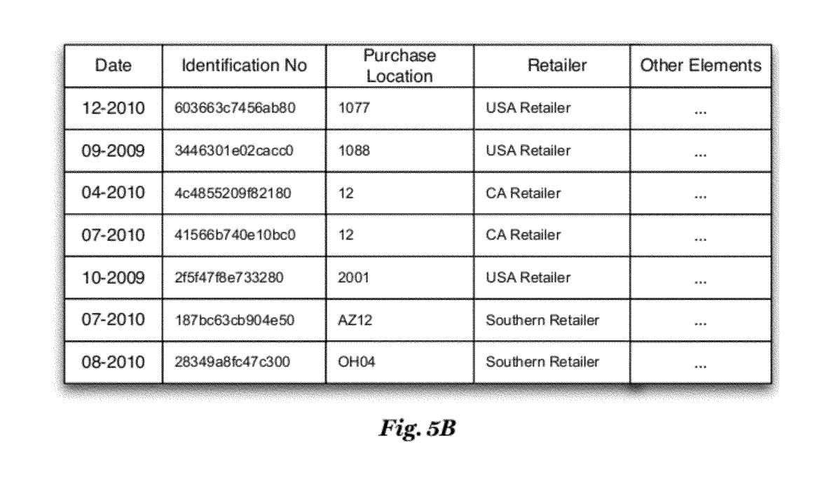

FIG. 5A shows a data structure diagram illustrating the portions of the data that may be useful in generating the unlocking and re-locking keys. The column labeled “T” represents a portion of a group identifier that indicates the method for generating an unlocking code. The column labeled “PP” represents an indicator to determine facts related to the manufacture of the electronic-device, for example, product category, product type, etc. The column labeled “VV” represents an indicator to determine the manufacture of the electronic-device.

The column labeled “K” represents an indicator of a portion of a group identifier that identifies a method for generating an unlocking code. For example, this column may represent the encryption key used and is required to decrypt the unlocking code which may be attached to the packaging of the electronic-device in an encrypted barcode.

The column labeled “FF” represents an indicator of the factory where electronic-device was manufactured. The column labeled “YY” represents an indicator of the date of manufacture.

The column labeled “SSSSSSSSSSS” represents a nearly-unique identifier, such as a serial number, that may be used to identify the electronic-device. As shown, the serial number can uniquely identify up to 100 billion electronic-devices with 11 characters of data.

The column labeled “CC” represents a checksum digit. For example, a CRC checksum may be used to validate the previous columns, that is, columns “T”, “PP”, “VV”, “K”, “FF”, “YY”, “SSSSSSSSSSS”. Together these columns (including the checksum) may represent the information that will be placed on a barcode or otherwise attached to the electronic-device. This information may be read by the point-of-sale system, for example, using a scanner. In some embodiments, this information may be compressed into 19 characters. This amount of information may fit on a two-dimensional barcode even while encrypted.

The column labeled “Key” represents a portion of an unlocking scheme, such as, the decryption key. In other embodiments, other portions of unlocking schemes may be supplied. This information may be held by the remote servers and provided to the retailer through the unlocking-code server.

The column labeled “Model” represents other manufacturing facts that may be held by the system. For example, these manufacturing facts may be useful in assisting validation of return of electronic-devices.

FIG. 5B shows a data structure diagram illustrating the portions of the data that may be useful in verifying returns and re-locking devices.

The column labeled “Date” represents the date that the electronic-device was sold. The column labeled “Identification No” represents the identifying data from FIG. 5A in columns, “T”, “PP”, “VV”, “K”, “FF”, “YY”, “SSSSSSSSSSS”, and “CC” which most likely will uniquely identify any electronic product.

The column labeled “Purchase Location” represents an identifier to identify the location of the retailer where the electronic-device was purchased. The column labeled “Retailer” represents an identifier to identify the retailer. The column labeled “Other Elements” represents other data and retail sales facts that may be collected at the time of purchase that may be useful in validating a return, for example, sale price, sales clerk, etc.

FIGS. 6 to 8 show a series of sequence diagrams illustrating simultaneous distribution methods for device identifiers and pass-codes. These three figures show three known approaches to distribution of unlocking codes. Other approaches may be derived from these.

These approaches allow distributing electronic-devices by physical channels and portions of unlocking schemes by either computer networking channels, or, by computer networking channels plus encrypted barcodes in physical channels. Electronic-devices from multiple manufacturers may be distributed to multiple retailers. The system maintains and transmits at least a portion of the unlocking scheme through the network channel separate from the physical channel. Some portions of the unlocking schemes might include: pass-codes, encryption keys, encryption algorithms, password generators, etc. Since manufacturers may want to change their encryption schemes, electronic-devices may be assigned to groups to permit a determination of the encryption scheme in use. This also permits distinguishing the encryption scheme used by one manufacturer to the next. The group identifier may be attached to the electronic-device, for example, as an unencrypted portion of the barcode. This unencrypted portion may be used to determine how to decrypt the encrypted portion. In some embodiments, the group identifier may be used to rotate through encryption keys, for example, where the group identifier may specify thirty different encryption keys, or thirty different encryption keys per manufacturer, or a different number of encryption keys that may be specified by the amount of data allocated to the group identifier for technical reasons. By extension, the group identifier may identify any other steps needed to generate the unlocking code or otherwise unlock the electronic-device.

Some password generation schemes may use manufacturing facts to programmatically generate the pass-code. Some examples of manufacturing facts include: consisting of manufacture date, manufacturer identifier, model identifier, and serial number. These facts may be manipulated, encrypted, and/or truncated to produce a pass-code. These same manufacturing facts may be present in the barcode in an unencrypted format, in some embodiments.

In some embodiments, instead of barcodes, other scanner readable indicia may be used. Other indicia may be selected based on factor such as the ability to hold longer amounts of encrypted information, economic considerations, programming considerations and security considerations.

These approaches may allow for variation of the encryption schemes depending on events, such as, a period of time or a unauthorized discovery of an encryption key, or other security breach. For example, in some embodiments, series of encryption keys may be used. An encryption key may be used for a period of time, then expired. After expiration, the system may prevent future use. Similarly, encryption keys may be put in and out of use based on security events. Group identifiers may be used to rotate through encryption keys or other portions of unlocking schemes, as appropriate.

FIG. 6 further shows a sequence diagram illustrating a dissemination method for device identifiers and pass-codes where the identifiers and pass-codes originate from outside the manufacturer.

During step 302, device identifiers are securely transmitted to the manufacturer. The device identifiers may be transferred from the computer network to barcode writers and test benches with a secured USB stick. Test benches are used for loading software or programming onto electronic-devices. This prevents the barcode writers and test benches from interacting with the insecure computer networks and reduces security risks related to unauthorized dissemination of the device identifiers and pass-codes. In an alternate embodiment, pass-codes are securely transmitted.

During step 303, the manufacturer will physically manufacture the electronic-device.

During step 306, the manufacturer will print barcodes with the device identifier. In some embodiments, a group identifier will also be printed. In some embodiments, the barcode will be encrypted, however, some portion of the barcode, such as the group identifier, may be used to determine the encryption key or other encryption scheme.

During step 308, the manufacturer will load the software onto the electronic-device, for example, using a test bench. During the software load, the locking functions that provide the locked and unlocked state will be provided. The software will include the device identifier, which may be used to generate the pass-code on the electronic-device. This may be later compared to the pass-code entered pursuant to purchase of the electronic-device. Using automated equipment, every electronic-device may be assigned a device identifier that may be read by the program stored on the electronic-device that can generate the unlocking code. In alternate embodiments, the pass-code may be stored with the program on the electronic-device, similar to the process in FIG. 7.

During step 310, the manufacturer will systematically label the electronic-device with the barcode. The manufacturer ensures that the device identifier on the barcode matches the device identifier programmed into the electronic-device. In some manufacturing environments, it may be necessary to label the circuit board, the enclosure of the electronic-device, and the product packaging so that the device identifier remains known through the manufacturing process. For example, the IMEI barcodes placed on mobile phones may use a similar process.

During step 312, the electronic-devices are shipped to retailers while the device remains in a locked state.

During step 313, the retailers receive device identifiers, group identifiers, encryption keys or other information needed to generate unlocking codes.

During step 316, the retailer sells a device. During step 318, The electronic-device is scanned, the device identifier is read. The unlocking-code server may use the device identifier and group identifier to determine the appropriate encryption key. The encryption key may be used to generate an unlocking code. The unlocking code generation program will use the same technique as the unlocking code program entered into the electronic-device.

The purchaser can enter the unlocking code to unlock the electronic-device. The unlocking code can be entered programmatically by the point-of-sale system. The unlocking code may be printed on a receipt. The unlocking code may be displayed on or near the point-of-sale.

During step 320, certain sales facts may be captured and associated with the device identifier. These may be used for validation of returns, see FIG. 9 and accompanying text.

FIG. 7A further shows a sequence diagram illustrating another dissemination method where the device identifiers originate from remotely from manufacturer and the pass-codes are encrypted into a barcode which may be decrypted with a key held outside the manufacturer.

During step 502, device identifiers are securely transmitted to the manufacturer. The device identifiers may be transferred from the computer network to barcode writers and test benches (used for loading software onto electronic-devices) with a secured USB stick. This prevents the barcode writers and test benches from interacting with the Internet and reduces security risks related to unauthorized dissemination of the device identifiers and pass-codes.

During step 503, the manufacturer will securely transmit the encryption keys used to read the encrypted barcode.

During step 506, the manufacturer will physically manufacture the electronic-device.

During step 508, the manufacturer will load the software onto the electronic-device, for example, using a test bench. In an embodiment, the electronic-device will be loaded with the device identifier, a manufacturer's serial number, and the pass-code. The locking program can compare the pass-code loaded on the device to the pass-code entered pursuant to sale of the device. Using automated equipment, every electronic-device may be assigned a device identifier that may be read by the program stored on the electronic-device that can generate the unlocking code.

During step 510, the manufacturer will determine the serial number, print a barcode with the device identifier and the pass-code. The barcode will be encrypted with the key provided during step 503. In some embodiments, a group identifier will also be printed, which can identify the appropriate decryption key. In some embodiments, other information may be included in the encrypted barcode, for example, the IMEI number for a cellular phone.

During step 512, the electronic-devices are shipped to retailers while the device remains in a locked state. During step 513, the retailers receive device identifiers, group identifiers, encryption keys or other information needed to decrypt barcodes to reveal unlocking codes.

During step 515, the retailer sells a device. During step 518, The electronic-device is scanned and the encrypted barcode is read. The encrypted information is sent to the local unlocking-code server. In some embodiments, the unlocking-code server will determine the group identifier to determine the encryption key. The encryption key may be used to decrypt the barcode and reveal the unlocking code. In some embodiments, decrypting the barcode may reveal other information stored in the barcode, for example, the IMEI code for a cellular phone.

The purchaser can enter the unlocking code to unlock the electronic-device. The unlocking code can be entered programmatically by the point-of-sale system. The unlocking code may be printed on a receipt. The unlocking code may be displayed on or near the point-of-sale.

During step 520, certain sales facts may be captured and associated with the device identifier. These may be used for validation of returns, see FIG. 9 and accompanying text.

FIG. 7B further shows a sequence diagram illustrating another dissemination method, similar to FIG. 7A, where the timing of the upload of the manufacturing facts occurs around the time of sale. This figure differs because the timing of step 503 is different. In this example, pass-codes are never entered into the remote server, they are only present in the encrypted barcode. This may have the benefit that a security compromise of the remote server will not reveal pass-codes.

During step 521, which may be part of step 519, manufacturing facts may be uploaded to the system, for example, manufacturer's serial number, device type, product category, etc. Since the manufacturing facts are loaded to the remote server at or after the time of sale, the needed manufacturing facts must be stored in the barcode. These uploaded facts may be associated with the device identifier on the remote system.

FIG. 8 further shows a sequence diagram illustrating another dissemination method where the identifiers, keys and/or pass-codes originate from the manufacturer and held outside the manufacturer.

During step 606, the manufacturer will physically manufacture the electronic-device.

During step 610, the manufacturer will determine the serial number, print a barcode with the device identifier and the pass-code. The barcode will be encrypted with the key that may be used later to decrypt the barcode. In some embodiments, a group identifier will also be printed, which can identify the appropriate decryption key. In some embodiments, other information may be included in the encrypted barcode, for example, the IMEI number for a cellular phone, or further example, additional manufacturing facts: serial number, model number, product category, etc.

During step 618, the manufacturer will load the software onto the electronic-device, for example, using a test bench. In an embodiment, the electronic-device will be loaded with the device identifier, a manufacturer's serial number, and the pass-code. The locking program can compare the pass-code loaded on the device to the pass-code entered pursuant to sale of the device. Using automated equipment, every electronic-device may be assigned a device identifier that may be read by the program stored on the electronic-device that can generate the unlocking code.

During step 620, device identifiers are securely transmitted to the manufacturer. The device identifiers may be transferred from the computer network to barcode writers and test benches (used for loading software onto electronic-devices) with a secured USB stick. This prevents the barcode writers and test benches from interacting with the Internet and reduces security risks related to dissemination of the device identifiers and pass-codes. This approach prevents the pass-codes from being stored in the remote servers, which prevents that data from being hijacked in transit to the server or while stored on the server.

During step 622, the electronic-devices are shipped to retailers while the device remains in a locked state. During step 623, the retailers receive device identifiers, group identifiers, encryption keys or other information needed to decrypt barcodes to reveal unlocking codes.

During step 625, the retailer sells a device. During step 628, The electronic-device is scanned and the encrypted barcode is read. The encrypted information is sent to the local unlocking-code server. In some embodiments, the unlocking-code server will determine the group identifier to determine the encryption key. The encryption key may be used to decrypt the barcode and reveal the unlocking code. In some embodiments, decrypting the barcode may reveal other information stored in the barcode, for example, the IMEI code for a cellular phone.

The purchaser can enter the unlocking code to unlock the electronic-device. The unlocking code can be entered programmatically by the point-of-sale system. The unlocking code may be printed on a receipt. The unlocking code may be displayed on or near the point-of-sale.

During step 630, certain sales facts may be captured and associated with the device identifier. These may be used for validation of returns, see FIG. 9 and accompanying text.

As shown by these examples, the timing and order of steps may be selected based on factors, such as, technical considerations, manufacturing process considerations, security considerations, when and how much information the manufacturer wants to reveal about the electronic-device, when and how much information the retailer wants to reveal about the terms and conditions of sale, consumer privacy laws, etc.

FIG. 9 shows a sequence diagram illustrating a method of verifying a return using sales info captured during the unlocking sequence.

When a retailer accepts a return of an electronic-device, the retailer may execute step 703 and scan the barcode of the electronic-device to determine the device identifier (see FIGS. 6 to 9 for a discussion of scanning barcodes).

During step 705, the device identifier may be transmitted to the remote servers so the sales facts and manufacturing facts may be downloaded to the retailer.

During step 707, the sales facts captured at the time of sale may be compared with the device identifier. For example, following types of queries may be ascertained: Does the manufacturer of the electronic-device being returned match the manufacturer of the device identifier? Does the product type match? Was the electronic-device ever recorded as sold? Is the retailer accepting the return of the electronic-device the same retailer that sold the electronic-device? The manufacturing facts and sales facts used to verify may be selected based on a variety of factors, including, how much information the manufacturer want to reveal about the electronic-device, how much information the retailer wants to reveal about the terms and conditions of sale, consumer privacy laws, etc.

During steps, 709, 711 and 713, if verification is successful, the electronic-device may be returned and the device may be re-locked, and the device identifier may be associated with a “non sold” status on the remote servers.

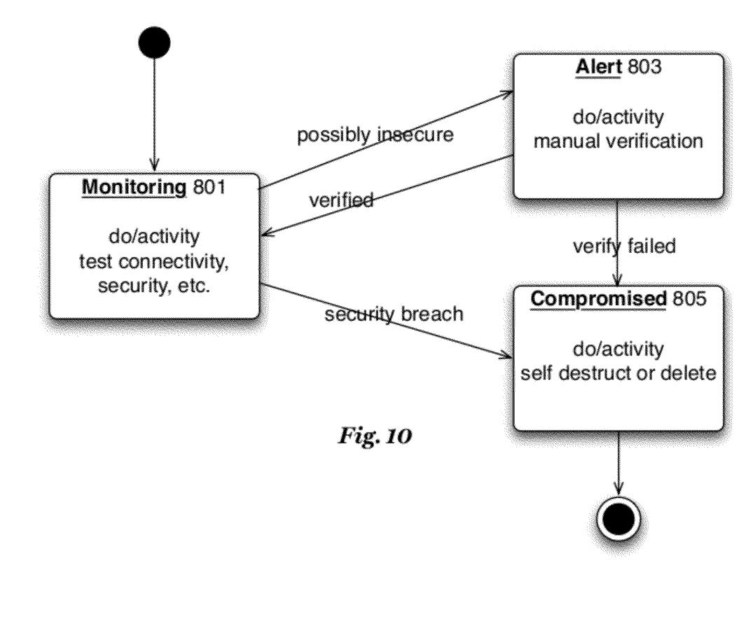

FIG. 10 shows a state chart diagram illustrating the states for a remote server for holding unlocking pass-codes, encryption keys, and other sensitive data within the retailer's physical location.

When starting up an unlocking-code server at a retail location, the unlocking-code server must authenticate with the remote servers. The information required to authenticate and maintain authentication may held only in volatile memory, which helps to ensure that the unlocking-code server may not be moved because movement generally requires disconnection from the power source.

After authentication, the unlocking-code server transitions to monitoring state 801, as shown. While in the monitoring state, unlocking-code server receives information from remote servers that is useful to generate unlocking codes. Additionally, remote servers will monitor the connectivity to the unlocking-code servers. Monitoring may be periodic and continuous. Remote servers may require other types of test or changes to determine if a unlocking-code server has been compromised. Remote server may require periodic re-authentication of the unlocking-code server, for example, changing of encryption keys for a virtual private network. If anomalies are detected, the state of the server will change.

Under some conditions, the state will change to alert status 803 as shown. For example if the unlocking-code server is unavailable for a period of time, the status may change to alert status 803. If the unlocking-code server remains unavailable, the state may change to compromised state 805 as shown. When in a compromised state, automated verification, human verification, or both may be used to transition to monitoring state 801 or compromised state 805, as shown.

When in compromised state 805, the remote servers may transmit a self destruct message so that the unlocking-code server destroys its own operating system or hardware. Alternately, a message may be sent requiring deletion of all information used to generate unlocking code and deletion of all information related to maintaining a secure connection to the remote servers. Likewise, the unlocking-code server may be able to detect compromise and initiate the state change to compromised state 805.

Clearly various changes may be made in the structure and embodiments shown herein without departing from the concepts described herein. Further, features of embodiments shown in the various figures may be employed with embodiments shown in the other figures. For example, each of the methods shown in FIGS. 6, 7A, 7B, and 8 may be used simultaneously with the architecture of FIG. 1. Therefore, the scope of the invention is to be determined by the terminology of the following claims and the legal equivalents thereof.

What is claimed is:

1. A method of deterring theft of electronic-devices comprising the steps of:
manufacturing an electronic-device with a locked state, unlocked state and a first portion of an unlocking function, wherein the locked state prevents use of the electronic-device, wherein the unlocked state allows use of the electronic-device, and wherein an unlocking function transitions the electronic-device from the locked state to the unlocked state;
shipping the electronic-device to a retail establishment while the electronic-device remains in the locked state;
transmitting over a computer network a second portion of the unlocking function to a volatile-storage server serving the retail establishment, wherein the volatile-storage server is configured and arranged to only maintain the second portion of the unlocking function in volatile storage while power is available from a power grid; and
providing the second portion of the unlocking function from the volatile-storage server to the purchaser after purchase of the electronic-device, thereby allowing entering the second portion of the unlocking function into the electronic-device and transitioning the device from a locked state to an unlocked state.

2. The method of claim 1 further comprising the step of:
physically securing the volatile-storage server from the checkout location at the retailer; and
maintaining connectivity between the checkout location and the volatile-storage server independently of any electronic connectivity used to receive the second portion of the unlocking function.

3. The method of claim 1 further comprising the step of:
periodically and continuously monitoring the volatile-storage server along the network connectivity used to receive the second-portion of the unlocking function;
detecting disconnection of the volatile-storage server from the network connectivity used to receive the second-portion of the unlocking function;
prompting for verification to ensure that the volatile-storage server is secure.

4. The method of claim 1 further comprising the step of:
periodically and continuously monitoring the volatile-storage server along the network connectivity used to receive the second-portion of the unlocking function; and
detecting compromise of the security of the volatile-storage server.

5. The method of claim 4 further comprising the step of:
sending a message to the volatile-storage server requiring self-destruction.

6. The method of claim 4 further comprising the step of:
sending a message to the volatile-storage server requiring deletion of the second-portion of the unlocking function.

7. The method of claim 4 further comprising the steps of:
physically securing the volatile-storage server from the checkout location at the retailer;
maintaining connectivity between the checkout location and the volatile-storage server independently of any network connectivity used to receive the second portion of the unlocking function;
periodically and continuously monitoring the volatile-storage server along the network connectivity used to receive the second-portion of the unlocking function;
detecting disconnection of the volatile-storage server from the network connectivity used to receive the second-portion of the unlocking function; and
prompting for verification to ensure that the volatile-storage server is secure.

8. The method of claim 7 wherein:
the unlocking function comprises a pass code, an encryption algorithm, an encryption key, and device identifier to identify the electric-device.

9. A method for distributing electronic-devices while deterring theft comprising the steps of:
allowing manufacturing, by a plurality of manufacturers, of groups of electronic-devices, wherein the electronic-devices comprise a locked state, unlocked state, an unlocking function, and a re-locking function wherein the locked state prevents use of the electronic-device, wherein the unlocked state allows use of the electronic-device, wherein an unlocking function transitions the electronic-device from the locked state to the unlocked state, and wherein the re-locking function transitions the electronic-device from the unlocked state to the locked state;
attaching a device identifier and manufacturing facts to the electronic-devices by embedding the identifier and facts into a scanner-readable indicia;
unlocking, during the time of sale of the electronic-devices, the electronic-devices by reading the scanner-readable indicia and transitioning the electronic-devices from the locked state to the unlocked state;
associating, during the time of sale of the electronic-devices, sales facts to the device identifier;
allowing return and re-locking of the electronic-device by transitioning the electronic-device from the unlocked state to the locked state after reading the scanner-readable indicia and validating the embedded manufacturing facts and associated sales facts.

10. The method of claim 9 wherein:
the manufacturing facts include manufacturer identifier and manufacture date.

11. The method of claim 9 wherein:
the manufacturing facts are selected from the group of facts consisting of manufacture date, manufacturer identifier, model identifier, and serial number.

12. The method of claim 1 wherein:
the sales facts include retailer identifier.

13. The method of claim 1 wherein:
the sales facts include purchase location.

14. A method for distributing electronic-devices while deterring theft comprising the steps of:
allowing manufacturing, by a plurality of manufacturers, of groups of electronic-devices, where the electronic-devices have a locked state, unlocked state and a password, wherein the locked state prevents use of the electronic-device, wherein the unlocked state allows use of the electronic-device, and wherein the password transitions the electronic-device from the locked state to the unlocked state to permit use of the electronic-device;
generating a series of passwords using a first encryption key for a first manufacturer, wherein the first manufacturer configures and arranges a first group of electronic-devices capable of being unlocked by the series of passwords;
receiving a second encryption key from a second manufacturer, wherein the second manufacturer configures and arranges a second group of electronic-devices to be unlocked by a password generated using the second encryption key;
allowing shipping to and displaying at a plurality of retail locations the first group and second group of electronic-devices;
electronically transmitting to the plurality of retail locations the first encryption key and the second encryption key;
providing a password to the purchaser of the electronic-device using either the first encryption key or the second encryption key, whereby allowing the purchaser to unlock the electronic-device.

15. The method of claim 14 further comprising:
attaching, to the electronic-device, a device identifier to identify the electronic-device and a group identifier to identify the group of electronic-devices;
encrypting the device identifier prior to the step of attaching using the encryption key associated with the group; and
reading the group identifier and encrypted device identifier, selecting the first or second encryption key associated with the first or second group;
decrypting the device identifier using the selected encryption key; and
generating the password using the device identifier.

16. The method of claim 14 further comprising:
attaching, to the electronic-device, a group identifier to identify the group of electronic-devices, and a password;
encrypting the password prior to the step of attaching using the encryption key associated with the group; and
reading the group identifier and encrypted password,
selecting the first or second encryption key associated with the first or second group; and
decrypting the password using the selected encryption key.

17. The method of claim 14 further comprising:
attaching, to the electronic-device, a device identifier to identify the electronic-device and a group identifier to identify the group of electronic-devices;
reading the group identifier and device identifier,
selecting the first or second encryption key associated with the first or second group; and
generating the password using the selected encryption key.

18. The method of claim 14 further comprising:
attaching, to the first group of electronic-devices, a series of device identifier to identify the electronic-devices and a first group identifier to identify the first group of electronic-devices;
reading, after purchase of an electronic-device from the first group, the group identifier and device identifier,
selecting the first encryption key associated with the first group;
generating the password using the first encryption key;
attaching, to the second group of electronic-devices, a group identifier to identify the second group of electronic-devices, and a series of passwords;
encrypting each password prior to the step of attaching using the second encryption key associated with the group; and
reading, after purchase of an electronic-device from the second group, the group identifier and encrypted password,
selecting the second encryption key associated with the second group; and
decrypting the password using the selected encryption key.

19. A method for distributing electronic-devices while deterring theft comprising the steps of:
allowing manufacturing of groups of electronic-devices by a plurality of manufacturers, where the electronic-devices have a locked state, unlocked state and a first portion of an unlocking function, wherein the locked state prevents use of the electronic-device, wherein the unlocked state allows use of the electronic-device, and wherein the unlocking function transitions the electronic-device from the locked state to the unlocked state after authentication pursuant to purchase of the electronic-device;
providing a first set of manufacturers a first series of device identifiers to identify a first group of electronic-devices and a related first set of a second portion of a first unlocking function, wherein the series of device identifier is attached to the first group of electronic-devices;
establishing with a second set of manufacturers a second series of device identifiers to identify a second group of electronic-devices, wherein the second series is related to a second set of a second portion of an second unlocking function;
allowing encrypting of the second set of second portion of a second unlocking function and attaching the encrypted second portion on a related second group of electronic-devices;
allowing shipping to and displaying at a plurality of retail locations the first group and second group of electronic-devices;
electronically transmitting to the plurality of retail locations the first series of device identifiers, the first set of a second portion of a first unlocking function, and the second series of device identifiers;
reading the device identifier after the sale of an electronic-device, determining if the device identifier belongs to the first series to provide the related second portion of the first unlocking function, or determining if the device identifier belongs to the second series to allow un-encrypting of the attached, encrypted second portion of the second unlocking function, whereby allowing the purchaser to unlock the electronic-device.

20. The method of claim 1g wherein:
the unlocking function comprises at least the one of the portions selected from the group consisting of encryption algorithm, encryption key, unlocking code.

21. The method of claim 19 wherein:
the unlocking function comprises a code generating program and an unlocking code.

22. The method of claim 1g wherein:
the unlocking function comprises manufacturing facts and a code generating program.

23. The method of claim 1g wherein:
the unlocking function comprises manufacturing facts and a code generating program.

24. The method of claim 23 wherein:
the manufacturing facts include manufacturer identifier and manufacture date.

25. The method of claim 23 wherein:
the manufacturing facts are selected from the group of facts consisting of manufacture date, manufacturer identifier, model identifier, and serial number.

26. A method for distributing electronic-devices while deterring theft comprising the steps of:
allowing manufacturing, by a plurality of manufacturers, of groups of electronic-devices, where the electronic-devices have a locked state, unlocked state and a password, wherein the locked state prevents use of the electronic-device, wherein the unlocked state allows use of the electronic-device, and wherein the password transitions the electronic-device from the locked state to the unlocked state to permit use of the electronic-device;
encrypting passwords with a series of encryption keys, wherein the manufacturer configures and arranges the groups of electronic-devices capable of being unlocked by the passwords, wherein each encryption key in the series of encryption keys is associated with a group from the groups of electronic devices;
attaching, to the electronic-devices, a group identifier to identify the group of electronic-devices and the encrypted password;
electronically transmitting to a plurality of retail locations the group identifier and the encryption keys used to encrypt passwords currently attached to electronic-devices;
providing a password to the purchaser of the electronic-device by reading the group-identifier and decrypting the encrypted password using the associated encryption key, whereby allowing the purchaser to unlock the electronic-device.

27. The method of claim 26 further comprising the steps of:
monitoring the integrity of encryption keys;
preventing future use of a compromised encryption key.

28. The method of claim 26 further comprising the steps of:
preventing future use of a compromised encryption key after the encryption key has been in use for a period of time.

29. The method of claim 26 wherein:
the series of encryption keys includes at least 30 encryption keys.
